(19) United States
(12) Patent Application Publication
(10) Pub. No.: US 2018/0178069 A1
(43) Pub. Date: Jun. 28, 2018

(54) GOLF BALL

(71) Applicant: Bridgestone Sports Co., Ltd., Tokyo (JP)

(72) Inventors: Katsunori SATO, Chichibushi (JP); Masanobu KUWAHARA, Chichibushi (JP)

(73) Assignee: Bridgestone Sports Co., Ltd., Tokyo (JP)

(21) Appl. No.: 15/822,405

(22) Filed: Nov. 27, 2017

(30) Foreign Application Priority Data
Dec. 26, 2016 (JP) 2016-250597

(51) Int. Cl. A63B 37/00; G06F 17/50

(52) U.S. Cl. CPC A63B 37/0012; A63B 37/002; A63B 37/009; G06F 17/5009; A63B 37/0018; A63B 37/0021; A63B 37/0007; A63B 37/0096

(57) ABSTRACT

In a golf ball having numerous dimples on its surface, at least a given proportion of the dimples are optimal dimples having momentum thicknesses smaller than those of reference model dimples, thereby increasing the aerodynamic performance at the ball surface and enabling an improved flight performance to be achieved.

### CROSS-REFERENCE TO RELATED APPLICATION

This non-provisional application claims priority under 35 U.S.C. § 119(a) on Patent Application No. 2016-250597 filed in Japan on Dec. 26, 2016, the entire contents of which are hereby incorporated by reference.

### TECHNICAL FIELD

This invention relates to a golf ball having numerous dimples formed on the surface thereof. More particularly, the invention relates to a golf ball which is designed to have a lowered air resistance and travel an increased distance by setting up a dimple model and air flow on a computer, employing arithmetic operations executed by the computer to analyze air flow over the dimple surfaces, and thus optimizing the dimples formed on the ball surface.

### BACKGROUND ART

It is well known that, in order for a golf ball that has been hit to travel a long distance, it is important for the ball itself to have a high rebound and for air resistance during flight by the dimples arranged on the ball surface to be reduced. Many methods for uniformly arranging dimples on the ball surface in the highest possible density so as to reduce air resistance have been described.

Although the shapes of the dimples formed on the surface of a golf ball are often circular, balls having also numerous non-circular dimples or having dimples of optimized cross-sectional shapes are described in, for example, JP-A H11-57065, JP-A 2008-93481 and U.S. Pat. Nos. 8,888,613 and 8,974,320.

However, no art has hitherto been described that suitably selects and sets the dimples to be formed on the ball surface while focusing on the momentum thickness per dimple.

### SUMMARY OF THE INVENTION

It is therefore an object of the present invention to provide a golf ball in which, using the momentum thickness to select optimal dimples in terms of the shapes of the dimples alone, the aerodynamic performance due to the dimple effect is increased even further, enabling the flight performance to be greatly enhanced.

The inventors have discovered that, with regard to the selection and arrangement/configuration of dimples formed on the surface of a golf ball, by making the dimples alone the direct object of evaluation, using a specific method to analyze the state of airflow over the dimple surfaces in a computerized simulation and determine the momentum thicknesses of the dimples, and designating dimples of given momentum thicknesses as “optimal dimples,” a dimple configuration having arranged therein at least a given ratio of these optimal dimples can definitely improve the aerodynamic properties, lower the air resistance and increase the distance traveled by the ball.

Accordingly, the invention provides a golf ball having numerous dimples formed on a surface thereof, wherein the dimples are of three or more types of differing diameters and, letting the momentum thickness θ of each dimple be calculated by steps (I) to (V) below, the number of dimples having smaller momentum thicknesses than reference model dimples is at least 30% of the total number of dimples:

(I) setting up, within a virtual space created in a computer, a geometric model representing a dimple that is a concave or convex region and a virtual airflow space which surrounds a periphery of the dimple model;

(II) generating a grid in the virtual airflow space and configuring the grid so as to be finer near a surface of the dimple model and to gradually increase in size in a direction leading away from the surface;

(III) establishing a state where an air stream of a given velocity flows into the virtual airflow space from in front of the dimple model;

(IV) letting a main direction of flow by the air stream within the virtual airflow space be the x-direction, a base direction of the dimple model be the y-direction, and a direction perpendicular to both the airstream main flow direction and the dimple model base direction be the z-direction, setting up an x-y plane that passes through the dimple; and

(V) calculating the momentum thickness θ in back of an arranged dimple.

The reference model dimples are defined as: (i) when the dimples being compared have a circular contour, being circular with a contour of the same diameter and surface area, having a cross-sectional shape that is a circular curve, and being adjusted to the same depth as the dimples being compared; and (ii) when the dimples being compared have a non-circular contour, being adjusted to a circular shape with a contour of the same surface area, having a cross-sectional shape that is a circular curve, and being adjusted to a depth that results in a volume which is the same as the volume of the dimples being compared from a hypothetical spherical surface.

In a preferred embodiment of the golf ball of the invention, in step (V), the dimple momentum thickness θ is a value measured at a Reynolds number=180,000 condition.

In another preferred embodiment of the invention, the number of dimples having smaller momentum thicknesses θ than the reference model dimples is at least 50% of the total number of dimples.

In yet another preferred embodiment, the momentum thicknesses θ of the respective dimples have an average value of 0.15 mm or less.

In a further preferred embodiment, the ball when struck has a coefficient of lift CL at a Reynolds number of 70,000 and a spin rate of 2,000 rpm which is at least 70% of the coefficient of lift CL at a Reynolds number of 80,000 and a spin rate of 2,000 rpm.

### Advantageous Effects of the Invention

In the golf ball of the invention, by arranging for at least a given proportion of the numerous dimples formed on the ball surface to be optimal dimples having momentum thicknesses smaller than those of reference model dimples, the aerodynamic performance of the ball surface can be further increased, making it possible to achieve the desired flight performance.

### BRIEF DESCRIPTION OF THE DIAGRAMS

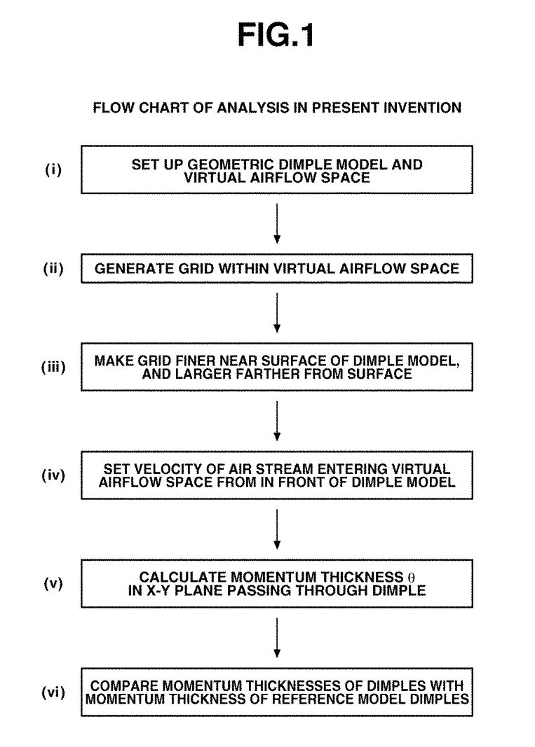

FIG. 1 is a flow chart showing an analytical procedure for evaluating dimple effects by analyzing the air stream at a dimple surface.

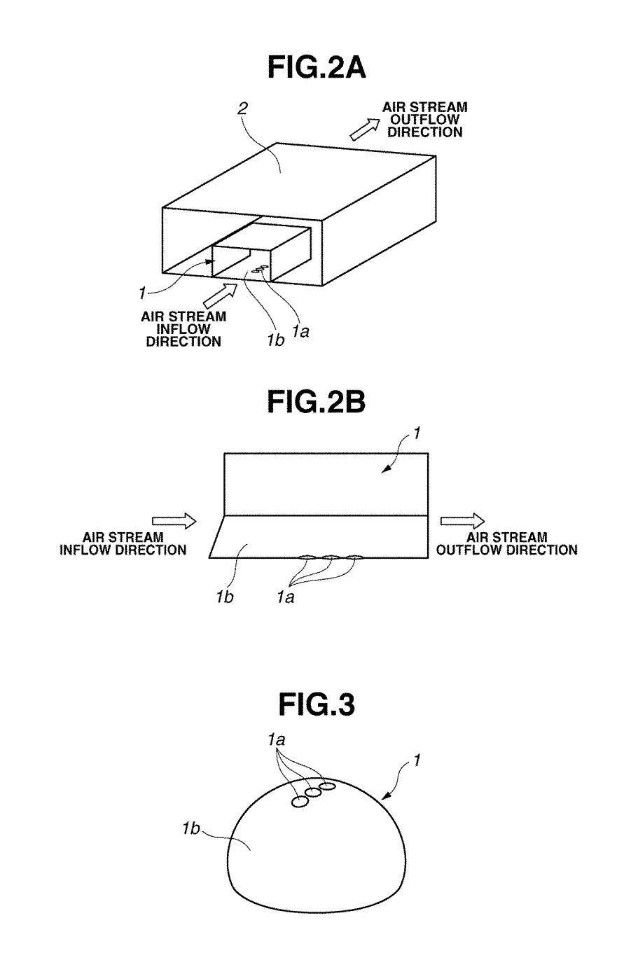

FIGS. 2A and B are explanatory diagrams showing a geometric dimple model and virtual airflow space in which concave or convex regions representing dimples on a flat plane (base) are used as the dimple model.

FIG. 3 is an explanatory diagram showing a geometric dimple model and virtual airflow space in which concave or convex regions representing dimples on a hemispherical surface representing a ball are used as the dimple model.

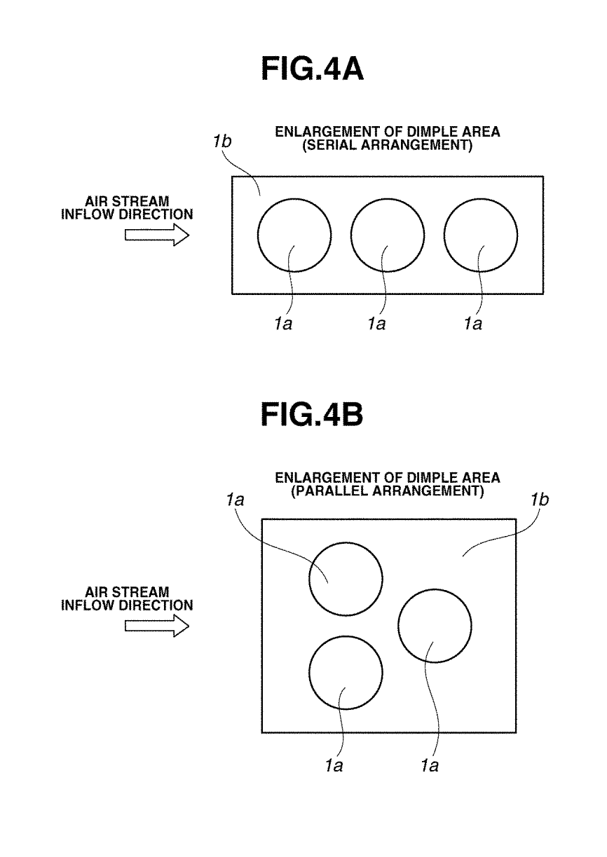

FIGS. 4A and B are enlarged plan views showing example arrangements of convex or concave regions representing dimples.

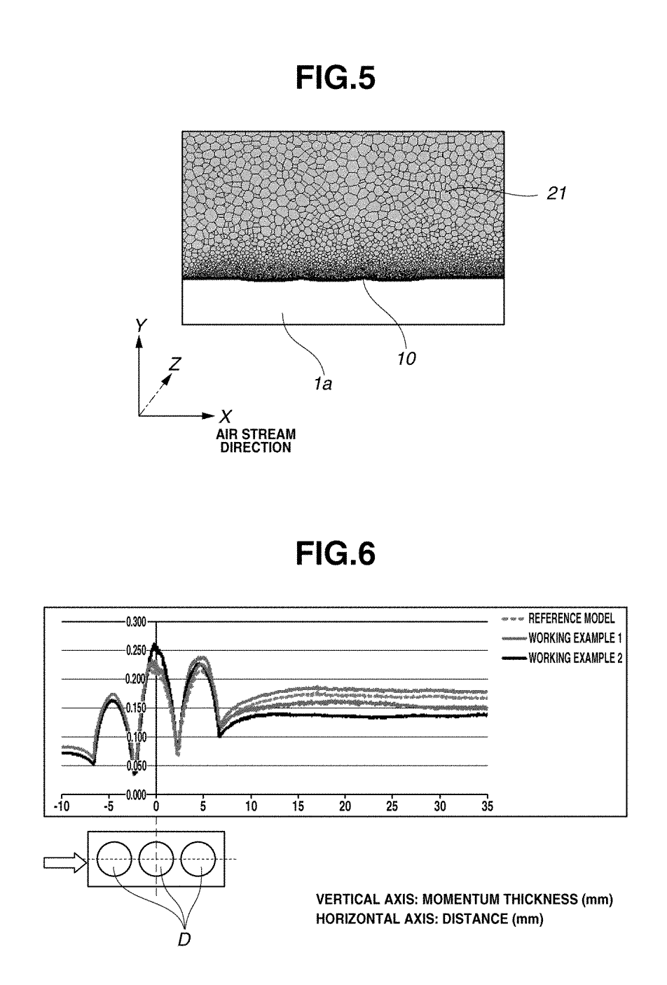

FIG. 5 shows a cross-section passing through the center of a geometric dimple model, this being an enlarged schematic view of the surface and surface vicinity of the dimple model.

FIG. 6 is an explanatory diagram illustrating measurement of the momentum thickness after an arranged dimple.

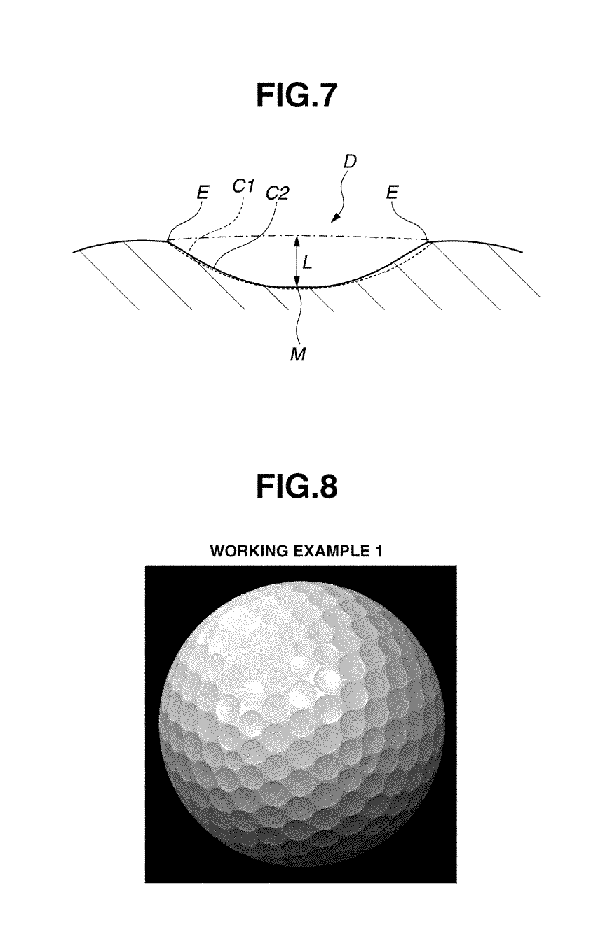

FIG. 7 is a schematic view showing the cross-sectional shape of a dimple.

FIG. 8 is a top view showing dimples on the surface of the golf ball in Working Example 1.

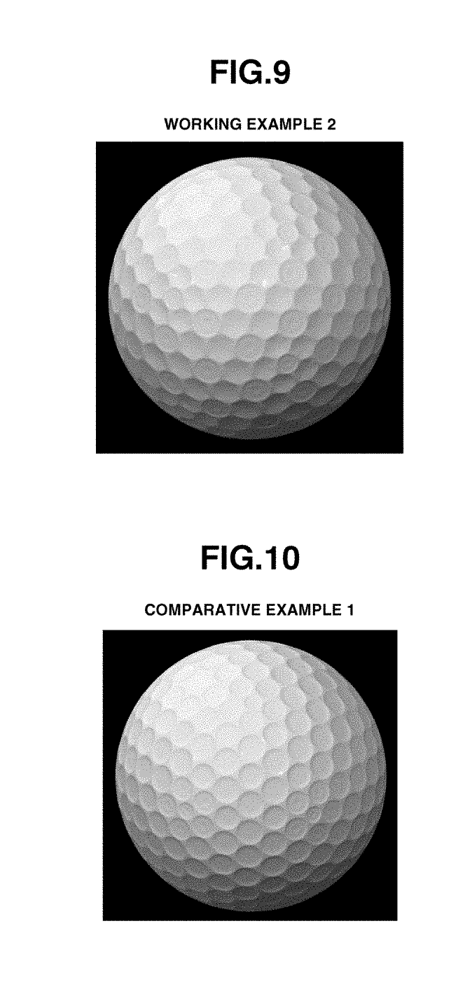

FIG. 9 is a top view showing dimples on the surface of the golf ball in Working Example 2.

FIG. 10 is a top view showing dimples on the surface of the golf ball in Comparative Example 1.

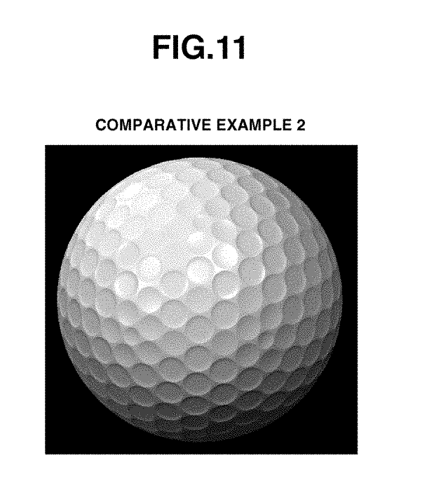

FIG. 11 is a top view showing dimples on the surface of the golf ball in Comparative Example 2.

### DESCRIPTION OF THE PREFERRED EMBODIMENTS

The objects, features and advantages of the invention will become more apparent from the following detailed description, taken in conjunction with the foregoing diagrams.

The golf ball of the invention has numerous dimples formed on the surface thereof, with dimples of three of more types of differing diameters being used.

Although the ball surface has three or more types of dimples of differing diameter thereon, it is especially preferable to use from three to five types of dimples of differing diameter. The dimples used in the invention have a diameter of preferably from 2.0 to 6.0 mm, and more preferably from 2.2 to 5.2 mm. As used herein, “dimple diameter” refers to the diameter of the flat plane circumscribing the edge of the dimple.

The dimples have a depth of preferably 0.3 mm or less. As used herein, “dimple depth” refers to, in the case of circular dimples, the maximum depth of the dimple from the flat plane circumscribing the edge of the dimple, and in the case of non-circular dimples, the maximum depth of the dimple from a hypothetical spherical surface of the ball.

It is recommended that the total number of dimples be generally at least 250, and preferably at least 300, and that the upper limit be not more than 500, and preferably not more than 450. When the total number of dimples is too small or too large, optimal lift may not be obtained and the ball may not travel as far as desired.

The top-view shape of the dimple may be suitably selected from circular as well as polygonal, teardrop, elliptical and other shapes.

The cross-sectional shape of the dimple may be obtained by suitably selecting and combining circular arcs, straight lines, sine function curves, cosine function curves and the like.

The proportion SR (%) of the total surface area of the hypothetical spherical surface of the ball that is circumscribed by the edges of the above dimples, sometimes referred to as the “dimple coverage ratio,” is generally at least 70%, and preferably at least 72%, with the upper limit being generally 100%, and preferably not more than 90%. At an SR value outside of this range, a suitable trajectory may not be obtained, possibly resulting in a decreased distance.

Specifically, of the momentum thicknesses θ calculated for each dimple by steps (I) to (V) below, the ball has arranged on the surface thereof at least a specific proportion of dimples having momentum thicknesses smaller than those of reference model dimples. Such “thin” dimples having smaller momentum thicknesses than reference model dimples are sometimes referred to below as “optimal dimples.”

(I) Set up, within a virtual space created in a computer, a geometric model representing a dimple that is a concave or convex region and a virtual airflow space which surrounds a periphery of the dimple model.

(II) Generate a grid in the virtual airflow space and configure the grid so as to be finer near a surface of the dimple model and to gradually increase in size in a direction leading away from the surface.

(III) Establish a state where an air stream of a given velocity flows into the virtual airflow space from in front of the dimple model.

(IV) Letting a main direction of flow by the air stream within the virtual airflow space be the x-direction, a base direction of the dimple model be the y-direction, and a direction perpendicular to both the airstream main flow direction and the dimple model base direction be the z-direction, set up an x-y plane that passes through the dimple.

(V) Calculate the momentum thickness θ in back of an arranged dimple.

First, in step (I), a geometric model representing a dimple that is a convex or concave region and a virtual airflow space surrounding the periphery of the dimple model are set up within a virtual space created in a computer (step (i) of the flow chart in FIG. 1).

FIGS. 2 and 3 show examples of this step of setting up a geometric dimple model and a virtual airflow space by computer. FIG. 2 includes a schematic perspective view of an embodiment in which a geometric dimple model and a virtual airflow region are set up within a virtual space. This model 1 is in the form of a box (rectangular cuboid; also referred to below simply as a “cuboid”), and uses convex or concave regions 1a representing dimples on a flat plane (base) 1b. FIG. 3 is an enlarged perspective view of an embodiment in which the model uses concave or convex regions 1a representing dimples on a hemispherical surface 1b representing a ball.

As shown in FIG. 2A, in this geometric dimple model 1, a plurality of dimples (concave or convex regions) 1a are set on the base 1b of a small rectangular cuboid. Were the concave or convex regions 1a to be set on top of the dimple model 1 that is a box (cuboid), it would be necessary to take into account the influence of the side walls or edges of the cuboid on the air stream inflow direction side thereof, as a result of which the number of unnecessary and pointless calculations and condition settings would end up increasing. To avoid external factors as much as possible and thus facilitate analysis and calculation, the dimples are set on the base of the cuboid. Given that the dimple model 1 is set within a virtual space 2 as shown in FIGS. 2A and B, depending on the arrangement of these two boxes (cuboids), the depth of the dimples that have been set on the base also is taken into account when carrying out analysis and calculations on specific dimples.

In cases where, as shown in FIG. 3, concave or convex regions 1a representing dimples on a hemispherical surface 1b are used as the geometric dimple model, unlike the embodiment in FIG. 2, the influence of air flow from in front of the hemispherical surface 1b is taken into account when carrying analysis and calculations on specific dimples.

In the invention, as noted above and shown in FIG. 2A, for example, a geometric dimple model 1 and a virtual airflow space 2 surrounding the periphery of the model 1 are set up within a virtual space. The dimple model 1 may be created by 3D CAD, for example. The virtual airflow space 2 may be given a cuboid shape of a given size with the dimple model 1 at the center. In FIG. 2, two cuboidal spaces are created: a small cuboid on the inside, and an outside cuboid. As subsequently described, a grid is finely formed in the virtual airflow space. By having the range over which this grid is finely formed serve as the interior of the small inside cuboid, it is possible to suitably control the grid size at the interior of this cuboid, enabling the analysis operations to be carried out smoothly and efficiently in a short time. It is essential for this virtual airflow space 2 to be set to a range which is the size of the air stream that exerts an influence on the dimple surfaces. The air stream at a distance from the dimple surfaces has only a small influence on the dimples; on the other hand, the accuracy of dimple effect simulation tends to decrease when the size of the virtual airflow space is too small. For this reason, the size of the virtual airflow space 2 may be suitably selected while also taking into consideration the efficiency or accuracy of simulation.

In the geometric dimple model, the number of concave or convex regions representing a dimple may be one or may be a plurality; preferably, this number is set to at least two. It should be noted, however, that as the number of concave or convex regions becomes larger, the time is takes to analyze airflow at the surface portions of the concave or convex regions increases, ultimately becoming impractical.

In FIG. 4A, three concave or convex regions 1a are arranged serially in the air stream inflow direction. By thus serially arranging a plurality of concave or convex regions 1a and observing, through continuous and fine-grained simulation, airflow changes at the surface portions of the concave or convex regions 1a (dimples) in the x-direction, dimple evaluation using a geometric dimple model in a state that approximates the movement of a golf ball having numerous dimples arranged on the surface is possible.

Alternatively, as shown in FIG. 4B, it is also possible to have the number of concave or convex regions simulating dimples be three or more and to arrange these concave or convex regions in parallel with respect to the main direction of flow by the air stream. In this case, by observing also, through continuous and fine-grained simulation, airflow changes at the surface portions of the concave or convex regions 1a (dimples) in the z-direction, which is a direction perpendicular to both the main direction of flow by the air stream and the base direction of the geometric dimple model, dimple evaluation using a dimple model in a state that approximates the movement of a golf ball having numerous dimples arranged on the surface is possible.

The contour shapes of the concave or convex regions representing dimples may be circular or non-circular.

Next, (II) a grid is generated in the virtual airflow space, and the grid is set up so as to be finer near a surface of the dimple shape model and to gradually increase in size in a direction leading away from the surface (steps (ii) and (iii) of the flow chart in FIG. 1).

Specifically, the concave or convex regions 1a within the geometric dimple model 1 are divided into cells measuring, for example, about 0.002 mm on a side, thereby setting up a large number of polygonal (e.g., triangular, quadrangular) or substantially polygonal (e.g., substantially triangular, substantially quadrangular) face cells. In addition, as shown in FIG. 5, grid cells 21 adjoining the surface 10 of the concave or convex region 1a within the dimple model 1 which is entirely covered by these individual face cells are set up. The grid cells 21 adjoining the surface 10 of the concave or convex region 1 are set up in substantially polygonal prismatic shapes such as substantially quadrangular prismatic shapes, or in substantially polygonal pyramidal shapes. Also, from the grid cells adjoining the surface 10 of the concave or convex region 1a, the remainder of the virtual airflow space 2 is divided grid-like into cells in such a way that the volume of the grid cells 21 gradually increases in directions leading away from the dimple model 1. In this way, the entire virtual airflow space 2 is divided into grid cells 21.

The grid cells formed in the virtual airflow space 2 may be given suitable three-dimensional shapes, such as those of a polygon mesh (polyhedrons), a tetra mesh (tetrahedrons), a prism mesh (triangular prisms), a hexa mesh (hexahedrons), or shapes that are mixtures thereof. Of the above, the use of a polygon mesh geometry or a tetra mesh geometry is especially preferred.

Because the air stream that exerts an influence on the dimple surface has a greater influence when close to the dimple, as shown in FIG. 5 and explained above, the grid cells are set up in such a way as to be finer near the concave or convex region 1a of the geometric dimple model 1 and to be coarser away from the concave or convex region 1a where the influence exerted by the air stream is small. The increase in the volume of the grid cells in directions leading away from the surface of the concave or convex regions 1a in the dimple model 1 may be continuous or stepwise.

Next, (III) a state where an air stream of a given velocity flows into the virtual airflow space 2 from in front of the geometric dimple model 1 is established (step (iv) of the flow chart in FIG. 1).

The velocity of the air stream is not particularly limited and may be suitably set in accordance with, for example, the anticipated flight velocity of the golf ball. Generally, the air stream velocity may be set to any velocity within a range of from 5 to 90 m/s.

Next, (IV) letting a main direction of flow by the air stream within the virtual airflow space be the x-direction, a base direction of the geometric dimple model be the y-direction, and a direction perpendicular to both the airstream main flow direction and the dimple model base direction be a z-direction, an x-y plane that passes through the dimple is set up and the momentum thickness θ is calculated (step (v) of the flow chart in FIG. 1).

That is, the elements of motion that arise when an air stream flows into the virtual airflow space 2 and comes into contact with a concave or convex region 1a within the geometric dimple model 1 are the velocity of the air stream in each axial direction in a three-dimensional spatial coordinate system, the direction of the air stream, and the pressure of the air stream against the surface of the dimple model 1. These elements of motion can be calculated by substituting numerical values into the basic equations used for computation; namely, the equations of continuity (1) to (3) below corresponding to the law of conservation of mass, and the Navier-Stokes equations (4) to (6) below corresponding to the law of conservation of momentum by a physical body.

In a simulation where, as shown in FIGS. 2A and B, air flows in the direction of the arrows at the surface of concave or convex regions 1a within the above geometric dimple model 1, the flow of air in each of the grid cells in the virtual airflow space 2 can be analyzed by arithmetic operations. Using the above equations (1) to (6) for the arithmetic operations, equations (1) to (6) can be discretized for the virtual airflow space 2 that has been partitioned into grid cells, and the operations carried out. The method of simulation used may be suitably selected from among, for example, finite-difference methods, the finite volume method, the boundary element method and the finite element method while taking into account parameters such as the simulation conditions.

$$\begin{matrix}\frac{\partial ρ}{\partial t} + \frac{\partial ( ρ u )}{\partial x} + \frac{\partial ( ρ v )}{\partial y} + \frac{\partial ( ρ w )}{\partial z} = 0 & ( 1 ) \\ divV = \frac{\partial ( ρ u )}{\partial x} + \frac{\partial ( ρ v )}{\partial y} + \frac{\partial ( ρ w )}{\partial z} & ( 2 )\end{matrix}$$

where u, v and w are the velocities in the x, y and z directions, respectively.
Using the divergence operator,

$$\frac{\partial ρ}{\partial t} + div ( ρ V ) = 0. \qquad ( 3 )$$

Letting F be the mass force,

$$\begin{matrix}\frac{Du}{Dt} = {F}_{x} - \frac{1}{ρ} \frac{\partial ρ}{\partial x} + \frac{μ}{ρ} ( \frac{{\partial }^{2} u}{\partial {x}^{2}} + \frac{{\partial }^{2} u}{\partial {y}^{2}} + \frac{{\partial }^{2} u}{\partial {z}^{2}} ) + \frac{1}{3} \frac{μ}{ρ} \frac{\partial }{\partial x} ( \frac{\partial u}{\partial x} + \frac{\partial v}{\partial y} + \frac{\partial w}{\partial z} ) & ( 4 ) \\ \frac{Dv}{Dt} = {F}_{y} - \frac{1}{ρ} \frac{\partial ρ}{\partial y} + \frac{μ}{ρ} ( \frac{{\partial }^{2} v}{\partial {x}^{2}} + \frac{{\partial }^{2} v}{\partial {y}^{2}} + \frac{{\partial }^{2} v}{\partial {z}^{2} } ) + \frac{1}{3} \frac{μ}{ρ} \frac{\partial }{\partial y} ( \frac{\partial u}{\partial x} + \frac{\partial v}{\partial y} + \frac{\partial w}{\partial z} ) & ( 5 ) \\ \frac{Dw}{Dt} = {F}_{z} - \frac{1}{ρ} \frac{\partial ρ}{\partial z} + \frac{μ}{ρ} ( \frac{{\partial }^{2} w}{\partial {x}^{2}} + \frac{{\partial }^{2} w}{\partial {y}^{2}} + \frac{{\partial }^{2} w}{\partial {z}^{2}} ) + \frac{1}{3} \frac{μ}{ρ} \frac{\partial }{\partial z} ( \frac{\partial u}{\partial x} + \frac{\partial v}{\partial y} + \frac{\partial w}{\partial z} ) & ( 6 )\end{matrix}$$

where ρ is the air density, p is the air pressure, and μ is the air viscosity.

Next, the momentum thickness θ is calculated from numerical data for air stream velocity in the respective axial directions of a three-dimensional space coordinate system, air stream direction and air stream pressure on the surface of the concave or convex region 1a that are calculated from equations (1) to (6) above.

$$θ = \frac{1}{{U}^{2 }} {\int }_{0}^{∞} u ( U - u ) dy$$

where θ is the momentum thickness, and U is the main flow velocity.

At the dimple surface and in the vicinity thereof, i.e., in a thin-layer region extremely close to the dimple surface, the influence of viscosity becomes pronounced, the velocity gradient du/dv becomes very large, and large frictional shear stresses act on the flow. The thin layer such as this along the surface of a physical body is called a “boundary layer.” By distinguishing between the boundary layer that lies along the surface of the body and has a large velocity gradient and the main flow to the outside thereof, the flow field can be divided up into a region exhibiting the properties of a viscous fluid and a region exhibiting the properties of an ideal fluid, and examined. Letting “u” be the velocity of the ultrathin layer close to the wall of the body and letting the symbol U represent the velocity of the overall layer outside of this ultrathin layer, referred to as the “main flow velocity,” the boundary layer thickness δ is often defined as the position where u=0.99U. Also, because the momentum (mass×velocity) within the boundary layer decreases more than in the flow of an ideal fluid, taking note of this loss, the momentum thickness θ is a physical quantity created with the idea of making the momentum per unit time when passing through a region of thickness θ at a velocity U equal to the loss of momentum in the actual boundary layer. The term u(U−u) in the above formula corresponds to the loss of momentum within the boundary layer.

The smaller this momentum thickness θ value, i.e., the closer it approaches to zero, the smaller the loss of momentum near the dimple surface, i.e., within the boundary layer. This result, by signifying a low air resistance, enables the dimple effect to be rated highly.

The dimple momentum thickness θ can be determined by, for example, as shown in FIG. 6, arranging the same three dimples in series and measuring about 15 to 30 mm backward from the center of the middle dimple. In FIG. 6, the vertical axis represents the momentum thickness (mm) and the horizontal axis represents the distance (mm) from the middle dimple. The reasoning here is that, because the dimple interior is readily subject to the influence of airflow turbulence, accurate values are difficult to obtain. Hence, in this invention, the momentum thickness θ is measured at the back of the dimple where the influence by the dimple on airflow has fully stabilized, which enables stable results to be achieved and thus makes it possible to obtain a golf ball having highly reliable momentum thickness θ values.

In step (v) of the flow chart in FIG. 1, as described above, letting a main direction of flow by the air stream within the virtual airflow space be the x-direction, a base direction of the geometric dimple model be the y-direction, and a direction perpendicular to both the airstream main flow direction and the dimple model base direction be the z-direction, an x-y plane that passes through the dimple is set up and the momentum thickness θ is calculated. The significance of setting up an x-y plane that passes through the dimple is to observe changes in the momentum acting on the dimple in this plane. Here, in setting up an x-y plane that passes through the dimple, it is preferable to set the x-y plane so as to pass through the center or near the center of the dimple, and calculate the momentum thickness in this plane. The reason is that, at or near the center of the dimple, changes in the momentum acting on the dimple are large. When setting up an x-y plane that passes through the dimple and calculating the momentum thickness θ, the dimple may be evaluated based on the average value of the momentum thicknesses determined in x-y planes at three or more places. Selecting such a means has the advantage of enabling dimple-induced changes in momentum to be more accurately expressed.

The above momentum thickness θ is the momentum thickness calculated in back of an arranged dimple after suitably setting the Reynolds number. Here, when deciding on the Reynolds number, the normal diameter of the golf ball (about 42.67 mm) is suitably selected as the characteristic length. In the case of golf balls, taking into consideration the head speed conditions by an ordinary amateur golfer, a Reynolds number 180,000 condition is suitable.

The Reynolds number (Re) is a non-dimensional number representing the ratio of the inertial force to the viscous force for a fluid. The formula for the Reynolds number, which can be used as an indicator of transition from laminar to turbulent flow, is as follows.

$$Re = \frac{ρ vL}{μ} = \frac{vL}{v}$$

where v: Average velocity relative to flow of fluid (SI units, m/s)
L: Characteristic length (distance fluid has flowed, etc.), m
μ: Fluid coefficient of viscosity (Pa·s, N·s/m², kg/(m·s))
ν: Coefficient of kinematic viscosity (ν=μ/ρ), m²/s
ρ: Density of fluid, kg/m²

That is, the Reynolds number is expressed as Re=(air density×velocity×characteristic length)/(coefficient of kinematic viscosity); hence, the velocity=(Re×viscosity coefficient)/(air density×characteristic length). In this invention, the diameter (42.67 mm) of the golf ball that is the object of analysis is used as the characteristic length, and so the velocity that is set takes temperature, air density and the like into account.

In order to even more accurately analyze and evaluate dimple-induced changes in momentum, when setting up an x-y plane passing through the dimple and calculating the momentum thickness θ, the dimple may be evaluated based on the average value for the momentum thicknesses in x-y planes at two or more places in the z-direction.

After setting up the x-y plane and calculating the momentum thickness θ, as shown in step (vi) of the flow chart in FIG. 1, a reference model is established. Dimples having smaller momentum thicknesses than this reference model are designated as “optimal dimples” and serve as an element of this invention. The thought is that because these “optimal dimples” have momentum thicknesses which are thinner than a given reference, their air resistances are small and so the aerodynamic performance due to concave or convex regions (dimples) within the geometric dimple model is high.

Next, the reference model is explained. The reference model dimples are defined as: (i) when the dimples being compared have a circular contour, being circular with a contour of the same diameter and surface area, having a cross-sectional shape which is a circular curve, and being adjusted to the same depth as that of the dimple being compared; and (ii) when the dimples being compared have a non-circular contour, being adjusted to a circular shape with a contour of the same surface area, having a cross-sectional shape which is a circular curve, and being adjusted to a depth that results in a volume which is the same as the volume of the dimples being compared from a hypothetical spherical surface.

Here, “circular curve” refers to, as shown in FIG. 7, a curve C2 in the shape of a circular arc that passes through two points E, E on the periphery (edge) of a dimple and through a point M of maximum depth L (mm). Depending on condition (i) or (ii) above, this circular curve corresponds to a circular curve C2 modified from the cross-sectional shape C1 of the dimple being compared.

The momentum thicknesses of the reference model dimples can be calculated by the same method as that used to measure the momentum thicknesses of the above dimples being compared.

The aforementioned “optimal dimples” account for at least 30%, preferably at least 50%, and more preferably at least 60%, of the total number of dimples on the surface of the ball. By adjusting the optimal dimples in this way, the air resistance is lowered, improving the aerodynamic performance and making it possible to achieve an increased distance.

In this invention, to obtain a higher aerodynamic performance, at a Reynolds number=180,000 condition, the average value of the momentum thicknesses θ of the respective dimples is preferably 0.15 mm or less, and more preferably 0.13 mm or less.

For shots taken with a distance club such as a number one wood (driver), a balance of lift and drag on the shot is suitable for obtaining a ball that travels a long distance, is particularly resistant to wind effects and has a good run. Also, lowering the drag or the coefficient of drag by itself is not very effective for increasing the distance of the ball on shots. When just the coefficient of drag is made smaller, the position of the ball at the highest point of the shot trajectory is extended, but there tends to be a loss of distance due to dropdown from insufficient lift in the low-velocity region after the highest point of the trajectory. Hence, in the golf ball of the invention, to obtain the desired distance-increasing effect, it is preferable to suitably adjust the lift or the coefficient of lift, and especially preferable to carry out adjustment such as to give a higher coefficient of lift under low-velocity conditions. Specifically, it is preferable for the coefficient of lift when the Reynolds number is 70,000 and the spin rate is 2,000 rpm just prior to reaching the highest point of the trajectory on the shot to be held to at least 70% of the coefficient of lift at a Reynolds number of 80,000 and a spin rate of 2,000 rpm shortly therebefore. The Reynolds numbers 80,000 and 70,000 correspond respectively to velocities of about 30 m/s and about 27 m/s when the 42.67 mm diameter of the golf ball is treated as the characteristic length.

Known methods of configuration and manufacture may be used to arrange all of the dimples, including the “optimal dimples” selected by the above-described method of selection in this invention, on the ball surface.

In deploying the dimples over the spherical surface, preferred use may be made of a method of arrangement in the form of a polyhedron such as an icosahedron, dodecahedron or octahedron, or with rotational symmetry about the ball axis, such as three-fold symmetry or five-fold symmetry. Also, this may be suitably employed not only for arranging circular dimples, but also non-circular dimples that include curved lines.

To fabricate a two-piece mold for molding the golf ball of the invention, a technique may be employed in which 3D CAD/CAM is used to directly cut the entire surface shape three-dimensionally into a master mold from which the golf ball mold is subsequently made by pattern reversal, or to directly cut three-dimensionally the cavity (inside walls) of the golf ball mold.

As with conventional golf balls, various types of coatings, such as white enamel coatings, epoxy coatings and clear coatings, may be applied to the ball surface. In such cases, to avoid marring the cross-sectional shape of the dimples, it is preferable to evenly and uniformly coat the surface.

The golf ball of the invention is not particularly limited with regard to the ball construction. That is, the present art may be applied to any type of golf ball, including solid golf balls such as one-piece golf balls, two-piece golf balls, and multi-piece golf balls having a construction of three or more layers. For example, although not shown in the attached diagrams, use may be made of a multilayer structure having an elastic core and a cover, and also having one or a plurality of intermediate layers interposed therebetween.

The elastic core is typically formed of a rubber composition made up primarily of polybutadiene. A known thermoplastic resin, especially an ionomer resin or a urethane resin, may be used as the intermediate layer or the cover material. The intermediate layer and the cover are formed of known resin compositions such as thermoplastic resins, and can be suitably adjusted to the desired Shore D hardnesses and layer thicknesses.

Ball characteristics such as the ball weight and diameter may be suitably set in accordance with the Rules of Golf. The ball can generally be formed to a diameter of not less than 42.67 mm and a weight of not more than 45.93 g.

### EXAMPLES

The following Examples and Comparative Examples are provided to illustrate the invention, and are not intended to limit the scope thereof. In this invention, the type, shape, size and other characteristics of the dimples in the attached diagrams are not limited and may be suitably selected within ranges that do not alter the gist and scope of the invention as described above.

### Examples 1 and 2, Comparative Examples 1 and 2

Use was made of the golf balls in Working Examples 1 and 2 and Comparative Examples 1 and 2 having dimples formed on the ball surface in differing designs. The internal construction of the ball was the same in each of the Working Examples and the Comparative Examples. That is, the core was produced to a diameter of 38.65 mm from a rubber composition made up primarily of polybutadiene rubber (BR01, from JSR Corporation). An ionomer resin material was then injection-molded over the surface of the core to form an intermediate layer having a thickness of 1.25 mm and a Shore D hardness of 63. The ionomer resin material used was an ionomer blend of the products available as Himilan® 1605, Himilan®1706 and Himilan® 1557 from DuPont-Mitsui Polychemicals Co., Ltd.

Next, a urethane resin material was injection-molded over the intermediate layer-encased sphere, thereby forming an outermost layer having a thickness of 0.8 mm and a Shore D hardness of 47. The urethane resin material was a urethane compound of the products available as Pandex T8283, Pandex T8290 and Pandex T9295 from DIC Bayer Polymer, Ltd.

The momentum thicknesses θ for the dimples in these respective Examples were calculated using a computer in accordance with the dimple model shown in FIG. 2 and the measurement conditions shown below. Details on the dimples in each Example are as indicated below. Top views of these are shown in FIG. 8 (Working Example 1), FIG. 9 (Working Example 2), FIG. 10 (Comparative Example 1) and FIG. 4 (Comparative Example 2).

### Measurement Conditions:

Grid shape: polygon mesh

Reynolds number: 180,000

Measurement cross-section: Z=0

Dimple model arrangement: three in series

Back direction: measured as X=15 to 30 mm
(with the center of the middle dimple model being X=0)

The method use for calculating the turbulent flow model was LES (Large Eddy Simulation).

### Establishment of Reference Model Dimples:

The reference model definitions are shown in Table 1 below. When the momentum thicknesses of dimples in the respective Examples are smaller than the momentum thicknesses of these reference model dimples, the dimples in the Examples are judged to be “optimal dimples.”

TABLE 1
(Establishment/Definition of Reference Model)

| Plan view shape of | | |
|---|---|---|
| dimple being compared | When circular | When non-circular |
| Contour shape | same | change to circular shape of |
| | | same surface area |
| Cross-sectional shape | circular arc | circular arc |
| Depth | same | set to depth that |
| | | results in same volume |

The low-velocity CL ratio and flight performance of the golf ball in the respective Examples were measured as described below. The results are shown in Table 2.

### Aerodynamic Properties (Low-Velocity CL Ratio)

The low-velocity CL ratio was determined by calculating the ratio of the coefficient of lift (CL) at a Reynolds number of 70,000 and a spin rate of 2,000 to the coefficient of lift at a Reynolds number of 80,000 and a spin rate of 2,000 rpm from the ball on its trajectory just after it has been launched with an Ultra Ball Launcher (UBL). The UBL is a device, manufactured by Automated Design Corporation, which includes two pairs of drums, one on top and one on the bottom. The drums are turned by belts across the two top drums and across the two bottom drums. The UBL inserts a golf ball between the turning drums and launches the golf ball under the desired conditions.

### Flight Performance

A driver (W#1) was mounted on a swing robot, and the distance traveled by the ball when hit at a head speed (HS) of 45 m/s and a spin rate of 2,600 rpm was measured. The club used was the PHYZ III (2014 model; loft angle, 10°) manufactured by Bridgestone Sports Co., Ltd.

TABLE 2

| | | Working | Working | Comparative | Comparative |
|---|---|---|---|---|---|
| | | Example 1 | Example 2 | Example 1 | Example 2 |
| Dimple type* | Optimal | 240 | | 48 | 48 |
| | dimples | (circular: 4.3/0.13) | | (circular: 3.9/0.12) | (circular: 3.9/0.13) |
| | | 72 | 98 | 12 | 26 |
| | | (circular: 3.9/0.12) | (circular: 4.5/0.14) | (circular: 2.5/0.13) | (circular: 2.5/0.13) |
| | | 12 | 12 | | 4 |
| | | (circular: 2.5/0.13) | (circular: 3.5/0.12) | | (circular: 4.3/0.13) |
| | | 14 | | | |
| | | (circular: 3.9/0.13) | | | |
| | Non-optimal | | 168 | 240 | 236 |
| | dimples | | (non-circular: —/0.230) | (circular: 4.3/0.13) | (circular: 4.3/0.11) |
| | | | 48 | 38 | 24 |
| | | | (non-circular: —/0.230) | (circular: 3.8/0.14) | (circular: 3.9/0.11) |
| Total number of dimples | | 338 | 326 | 338 | 338 |
| Number of optimal dimples | | 338 | 110 | 60 | 78 |
| Number of non-optimal dimples | | 0 | 216 | 278 | 260 |
| Optimal dimple ratio (%) | | 100 | 33.7 | 17.8 | 23.1 |
| SR (%) | | 80 | 80.0 | 78.0 | 78.0 |
| Low-velocity CL ratio | | 81 | 80 | 72 | 65 |
| Flight | Carry (m) | 216.7 | 215.1 | 214.8 | 213.2 |
| performance | Total | 227.4 | 226.2 | 224.7 | 224.3 |
| (HS, 45 m/s) | distance (m) | | | | |

*Information within parentheses indicates (contour shape: diameter (mm)/depth (mm)).

When the contour shape is non-circular, the depth (mm) shown is the depth from the hypothetical spherical surface.

In the table, “SR” is the ratio (units:%) of the sum of the individual dimple surface areas, each defined by the flat plane circumscribed by the edge of a dimple, with respect to the hypothetical spherical surface area of the ball were it to have no dimples thereon.

As is apparent from Table 2, the golf balls in Working Examples 1 and 2, in which the number of “optimal dimples” defined by this invention was set to at least 30% of the total number of dimples, have a greatly increased distance relative to the golf balls in Comparative Examples 1 and 2 having few “optimal dimples.” This is presumably because the aerodynamic performance effects of the dimples have increased even further.

Japanese Patent Application No. 2016-250597 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A golf ball comprising numerous dimples formed on a surface thereof, wherein the dimples are of three or more types of differing diameters and, letting the momentum thickness θ of each dimple be calculated by steps (I) to (V) below, the number of dimples having smaller momentum thicknesses than reference model dimples is at least 30% of the total number of dimples:
(I) setting up, within a virtual space created in a computer, a geometric model representing a dimple that is a concave or convex region and a virtual airflow space which surrounds a periphery of the dimple model;
(II) generating a grid in the virtual airflow space and configuring the grid so as to be finer near a surface of the dimple model and to gradually increase in size in a direction leading away from the surface;
(III) establishing a state where an air stream of a given velocity flows into the virtual airflow space from in front of the dimple model;
(IV) letting a main direction of flow by the air stream within the virtual airflow space be the x-direction, a base direction of the dimple model be the y-direction, and a direction perpendicular to both the airstream main flow direction and the dimple model base direction be the z-direction, setting up an x-y plane that passes through the dimple; and
(V) calculating the momentum thickness θ in back of an arranged dimple;
which reference model dimples are defined as, (i) when the dimples being compared have a circular contour, being circular with a contour of the same diameter and surface area, having a cross-sectional shape that is a circular curve, and being adjusted to the same depth as the dimples being compared; and (ii) when the dimples being compared have a non-circular contour, being adjusted to a circular shape with a contour of the same surface area, having a cross-sectional shape that is a circular curve, and being adjusted to a depth that results in a volume which is the same as the volume of the dimples being compared from a hypothetical spherical surface.

2. The golf ball of claim 1 wherein, in step (V), the dimple momentum thickness θ is a value measured at a Reynolds number=180,000 condition.

3. The golf ball of claim 1, wherein the number of dimples having smaller momentum thicknesses θ than the reference model dimples is at least 50% of the total number of dimples.

4. The golf ball of claim 1, wherein the momentum thicknesses θ of the respective dimples have an average value of 0.15 mm or less.

5. The golf ball of claim 1, wherein the ball when struck has a coefficient of lift CL at a Reynolds number of 70,000 and a spin rate of 2,000 rpm which is at least 70% of the coefficient of lift CL at a Reynolds number of 80,000 and a spin rate of 2,000 rpm.
